(19) United States
(12) Patent Application Publication
(10) Pub. No.: US 2005/0258079 A1
(43) Pub. Date: Nov. 24, 2005

(54) Pressurized screen for screening a fibrous suspension and use thereof

(75) Inventors: Reimund Rienecker, Heidenheim (DE); Stefan Rippl, Ravensburg (DE); Peter Schweiss, Elchingen (DE)

Correspondence Address: GREENBLUM & BERNSTEIN, P.L.C., 1950 ROLAND CLARKE PLACE, RESTON, VA, 20191, US

(73) Assignee: VOITH PAPER PATENT GmbH, Heidenheim (DE)

(21) Appl. No.: 11/131,358

(22) Filed: May 18, 2005

(30) Foreign Application Priority Data
May 21, 2004 (DE) 10 2004 025 149.5

(51) Int. Cl. B07B 1/00; D21C 9/08; B07B 1/20

(52) U.S. Cl. 209/240; 162/55; 209/306

(57) ABSTRACT

Pressurized screen and process for screening a fibrous suspension, in which the pressurized screen includes a housing and at least one wire arranged in the housing. The at least one wire has a plurality of openings and a center line of running essentially vertically. A tangential inflow is coupled to an inflow chamber, and an accepted-stock chamber is coupled to an accepted-stock outlet, such that the at least one wire being positioned in a flow path between the inflow chamber and the accepted-stock chamber. At least one reject outlet is provided, as well as a driven wire scraper located in the accepted-stock chamber driven in a circumferential direction opposed to an inflow direction of the suspension through the tangential inflow, and a light-particle outlet coupled to an upper part of the inflow chamber.

### CROSS-REFERENCE TO RELATED APPLICATIONS

The present application claims priority under 35 U.S.C. §119 of German Patent Application No. 10 2004 025 149.5, filed on May 21, 2004, the disclosure of which is expressly incorporated by reference herein in its entirety.

### BACKGROUND OF THE INVENTION

1. Field of the Invention

The invention relates to a pressurized screen for screening a fibrous suspension with at least one cylindrical or conical wire inserted in a housing. The center line of the wire runs essentially vertically in the position of use of the device and is provided with a plurality of wire openings, through which a part of the fibrous suspension fed through a tangential inflow into an inflow chamber can pass and reach an accepted stock chamber, to which an accepted stock outlet is attached. Another part of the suspension is rejected at the wire openings and is guided out of the screening device separately through at least one reject outlet as reject. In this manner, a driven wire scraper is located in the accepted stock chamber, and is driven such that its circumferential speed is opposed to that of the tangential inflow direction at the inflow.

2. Discussion of Background Information

Pressurized screens are used in treating paper stock suspensions in order to process the fibrous suspension in a wet screening. For this purpose, a pressurized screen of this type contains at least one wire which includes a plurality of openings. The fibers contained in the suspension are intended to pass through the openings, while the undesired solid components are rejected at it and conducted out of the screen again. Round holes or slits are typically used as the screen openings. In most cases, pressurized screens of the type under consideration here are also equipped with wire scrapers that are moved past the wire close to it. The clogging of the wire openings is thus prevented in a manner known per se.

The separating effect of a pressurized screen is thus attributable to the fact that at least part of the contaminants contained in the fed paper stock suspension cannot pass through the wire, and thus is separated from the paper fibers due to size, shape or flexibility. Pressurized screens are also known in which in addition a separation specifically aimed at the density of the foreign particles is carried out in that the different forces of the foreign particles in a centrifugal field are utilized. Even though the separation effect can be optimally achieved only in hydrocylones and centrifuges, it can nevertheless also be useful in pressurized screens. Although the majority of heavy contaminants would not pass through the screen openings typically used anyway, thus would be rejected there, there is the danger of damage or wear when they come into contact with the wire. This risk is further increased in that wire scrapers are almost always used which move past the wire very close to it at a relatively high speed.

It is easily possible to protect against coarse heavy particles those pressurized screens that are used with paper stock suspensions with a high content of foreign particles through upstream hydrocyclones, so-called high-consistency cleaners. Although this is effective, it is associated with additional expense.

Another measure to reduce wear on the wire of the pressurized screen is to arrange the wire scraper on the accepted stock side of the wire. This means that the particles rejected at the wire have a lower speed and cannot be collected by the wire scraper. In particular damage by jamming metal parts between the wire and the wire scraper is highly unlikely.

In the case of pressurized screens of the type considered here equipped with cylindrical screen baskets, a centripetal mode of operation is often used in which the suspension passes through the wire openings radially from the outside inwards. Heavy particles cannot therefore reach the wire so easily due to the centrifugal forces.

Pressurized screens are known from DE-A-28 30 386 and from DE 12 31 539 B in which the suspension to be cleaned is guided centripetally through a cylindrical screen basket and in which the wire scrapers run in the accepted stock. Thereby in one embodiment according to DE 12 31 539 B the rotor is driven so that its circumferential speed is opposed to that of the suspension flowing in. This screen carries away downwards both heavy and light contaminants.

Despite this progress, the operation of pressurized screens of this type is very problematic. Thus it cannot be ruled out that in particular with suspensions with a high content of foreign particles, such as, e.g., have to be treated directly after the recovered paper slushing in the primary screening, heavy particles, e.g., metal pieces, glass fragments and stones, scrape along the wire and lead to increased wear. Also light particles, in particular foams (Styrofoam) are not removed or at least not optimally and quickly. With them there is the danger that they are broken up so much in the pressurized screen that they reach the accepted stock and it is hard to separate them out in the subsequent separation stages. Or they are concentrated in the pressurized screen and block the flow paths to the wire or the wire openings themselves.

### SUMMARY OF THE INVENTION

The present invention improves known pressurized screens so that a considerable part of the foreign particles can already be removed from the paper stock suspension before they reach the wire. Thereby in particular heavy particles encouraging wear and sensitive light particles should be removed at an early stage.

This invention is directed to a pressurized screen that includes a light particle outlet connected to an upper part of the inflow chamber.

With the pressurized screen of the type mentioned, much more favorable flow conditions can be obtained through the measures according to the invention, which applies in particular to the inflow chamber. In general this is ring-shaped and is supplied with the fibrous suspension to be screened through an inflow attached tangentially, through which a rotational flow develops. As a result of the centrifugal forces thus generated, the heavy particles are centrifuged radially outwards so that they do not come into contact with the wire at all or hardly at all. They float in the direction of the inner wall of the housing and are in part dragged further by the suspension flow and in part transported by gravity into a part of the inflow chamber from which they can easily be removed. The wire scraper rotating radially inside the wire—thus on the accepted stock side—generates pressure and suction impulses in the accepted-stock chamber to clear the wire openings. The wire scraper thereby has a direction of rotation that is directed in an opposite manner to the direction of rotation of the rotating liquid ring located in the inflow chamber. This is advantageous since the scraper blades in interaction with the wire generate a reverse rotation flow in the inflow chamber, thus drive the suspension located in the inflow chamber in the direction that it already has from the inlet. The light particles are separated from the heavy particles by the centrifugal forces and move upwards along the wire and can easily be carried away. Due to the marked rotational flow also directly at the wire, the tendency of the light particles to adhere to it is slight. In this manner the separation effect of heavy particles and of light particles in the inflow chamber is considerably improved without additional expense in terms of equipment and with approximately the same energy consumption.

The present invention is directed to a pressurized screen for screening a fibrous suspension that includes a housing and at least one wire arranged in the housing. The at least one wire has a plurality of openings and a center line of running essentially vertically. A tangential inflow is coupled to an inflow chamber, and an accepted-stock chamber is coupled to an accepted-stock outlet, such that the at least one wire being positioned in a flow path between the inflow chamber and the accepted-stock chamber. At least one reject outlet is provided, as well as a driven wire scraper located in the accepted-stock chamber driven in a circumferential direction opposed to an inflow direction of the suspension through the tangential inflow, and a light-particle outlet coupled to an upper part of the inflow chamber.

In accordance with a feature of the invention, the at least one wire may be cylindrical or conical.

According to another feature of the instant invention, the at least one wire can be positioned to separate the accepted-stock chamber, which lies radially inside from the inflow chamber, which lies radially outside.

Moreover, the pressurized screen can also include a heavy-particle outlet, such that the inflow chamber is connected to the heavy-particle outlet. The heavy-particle outlet may be coupled to a lower part of the inflow chamber. Further, an intermittently activatable heavy-particle sluice may be coupled to the heavy-particle outlet.

According to another feature of the invention, the inflow chamber can have a conically tapering section.

In accordance with still another feature of the invention, the inflow may lies geodetically above the reject outlet.

According to a further feature of the invention, a vent line can be coupled at an upper part of the accepted-stock chamber.

The wire scraper may be embodied to generate pressure and suction impulses to a surrounding liquid in the direction of the wire through relative movement with the wire.

Further, the inflow chamber can be closed below by an incline, and the heavy-particle outlet can be coupled to a lowest point of the incline.

According to the invention, the inflow chamber can be closed below by an end wall running obliquely, and the reject outlet may be coupled to a lowest point of the end wall.

Moreover, the inflow chamber may be closed above by an incline, and the light-particle outlet can be coupled to a highest point of the incline.

The present invention is directed to a process for cleaning a suspension produced from recovered paper in the pressurized screen, as discussed above. The process includes producing a suspension by slushing in a dissolving drum, and holding back foreign particles contained in the suspension at wire openings due to size, type and shape.

According to the invention, the wire openings are round with a diameter greater than 1 mm. Further, the diameter may be greater than preferably greater than 3 mm.

The process may also include screening and diluting the suspension in the wire, and pumping the suspension into the pressurized screen.

The present invention is directed to a process for cleaning a suspension produced from recovered paper in the pressurized screen discussed above. The process includes producing a suspension by slushing in a pulper, and holding back foreign particles contained in the suspension at round wire openings having a diameter greater than 1 mm due to size, type and shape.

In accordance with the invention, the diameter may be greater than 3 mm.

The process can also include pumping the suspension from the pulper directly into the pressurized screen through the at least one wire arranged in the pulper.

In accordance with still yet another feature of the present invention, the suspension may be guided into the pressurized screen with a consistency between 2% and 4%.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a sectioned side view of a pressurized screen according to the invention;

FIG. 2 illustrates a sectioned plan view of the pressurized screen according to the invention;

FIGS. 3 and 4 illustrates an alternative embodiment of the invention in a side view; and

FIG. 5 illustrates an advantageous use of the pressurized screen according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

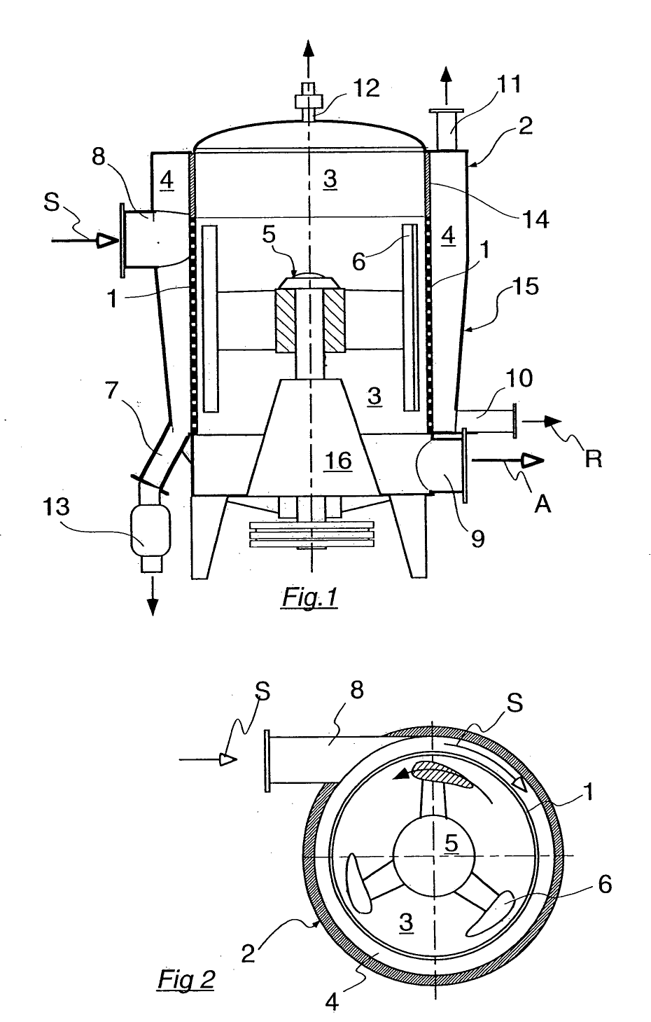

FIG. 1 shows a typical embodiment of the pressurized screen according to the invention. It contains in a housing 2 a wire 1 in the form of a cylindrical screen basket. In the position of use of the device, the center line of the wire 1 runs vertically here. It is therefore also referred to as a vertical screen. The wire openings are advantageously cylindrical with a diameter between one and three millimeters over their entire length. The fibrous suspension S to be screened is fed into the housing 2 through an inflow 8. It thereby first reaches the inflow chamber 4 which extends essentially in a ring-shaped manner and radially outside the wire 1 as a part of the housing 2. As can be seen from FIG. 2, the inflow 8 is tangentially connected to the inflow chamber 4 so that when the machine is in operation a rotational flow forms in the inflow chamber 4 which runs clockwise in this representation.

The fed fibrous suspension S moves downwards in the inflow chamber 4 in a helical manner, whereby a substantial part of this suspension can pass through the wire opening of the wire 1 and arrive at the accepted-stock chamber 3 lying radially inside the wire 1. The circumferential speed of the suspension is maintained or increased through a conically tapering section 15 of the inflow chamber 4, even if the quantity decreases due to discharge through the wire 1.

The wire scraper 5 is located in the accepted-stock chamber 3, which wire scraper is here provided with a number of blades 6 that are preferably driven at a circumferential speed of at least 15 m/s. Through relative movement to the liquid surrounding them, they generate pressure and suction impulses with which the wire openings are kept clear. The wire scraper 5 is suspended in the lower part of the housing 2 (bearing and sealing unit 16) and is driven in a rotating manner. As FIG. 2 shows, the wire scraper 5 is driven such that its circumferential speed is opposed to the tangential inflow direction at the inflow 8. The advantages of this contrarotation have already been mentioned. Centrifugal forces act on the fibrous suspension S due to the rotational flow formed in the inflow chamber 4. These forces lead to heavy particles being centrifuged outwards, thus in the direction of the housing wall. They are thus effectively prevented from contact with the wire 1. They collect in the lower part of the inflow chamber 4 and are guided away, e.g., via the heavy-particle outlet 7 into the heavy-particle sluice 13, whereby hardly any fiber losses are incurred. In typical cases the fibrous suspension S to be screened is contaminated not only by heavy particles, but also by light particles, including in particular Styrofoam or other light foams. They are quickly separated from the heavy particles due to the centrifugal forces and can be removed at an early stage, since they move in the upper part in the inflow chamber 4 filled with liquid due to their ascending tendency. They are there carried away through the light-particle outlet 11. This can lead vertically upwards, as here, or obliquely upwards, or it can also be connected tangentially. It can be advantageous to provide an impermeable cylinder wall 14 lying above the wire 1 for separating the inflow chamber 4 and the accepted-stock chamber 3, so that a light-particle collection chamber forms in the upper part of the inflow chamber 4. A clear settling of the flow can occur therein, through which the light particles and possibly air can be better separated. The axial length of this cylinder wall 14 is thereby only a fraction of the axial length of the wire 1, e.g., approx. 20%. The ascending effect of the light particles can be additionally supported in this area by a fixed helix thread that deflects the circumferential movement into an ascending movement.

Most of the suspension rejected at the wire 1, in particular the foreign particles entrained through flow forces, are removed from the housing 2 at the reject outlet 10 as reject R. As a rule it is post-screened, in order to avoid fiber losses.

The accepted-stock chamber 3 here features a vent line 12 in its uppermost part, through which line air and possibly also very fine light particles can be removed from the accepted stock.

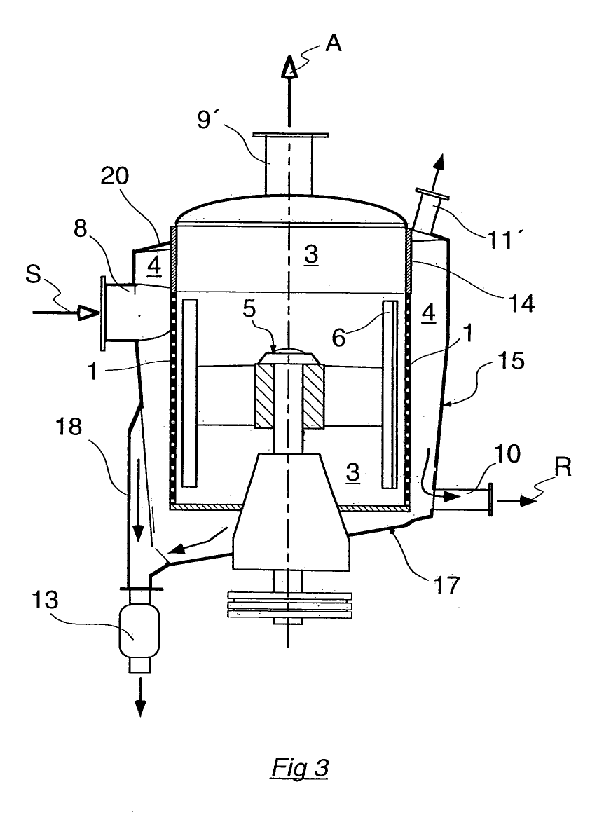

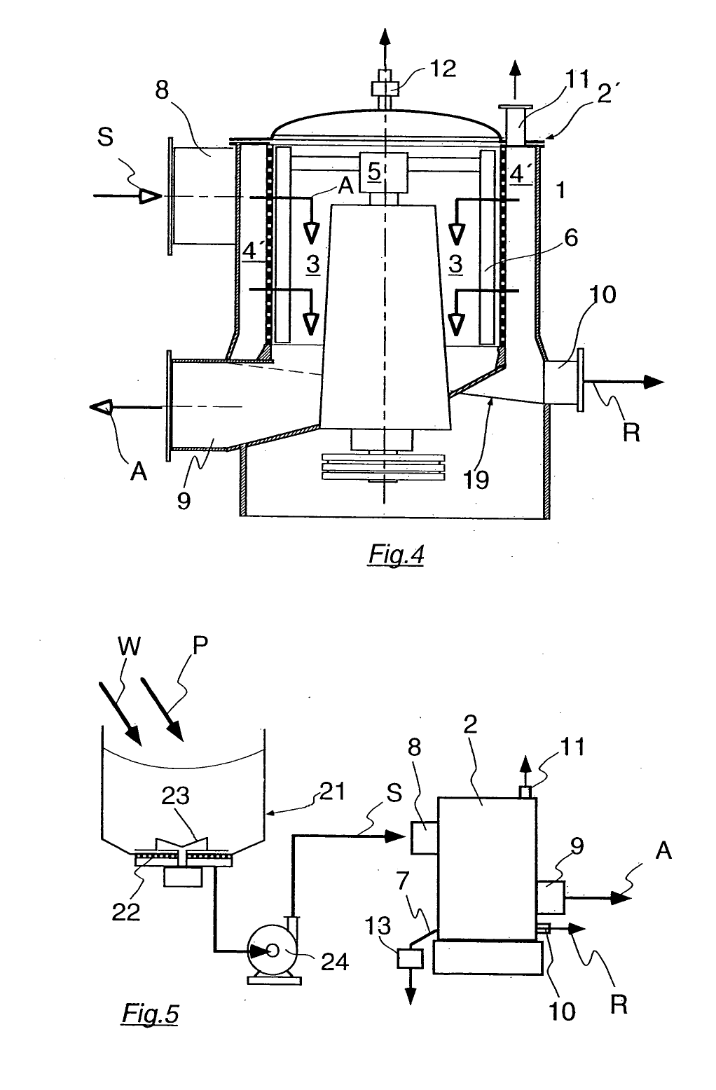

FIGS. 3 and 4 serve to show further solutions with special details. Thus the device according to FIG. 3 has an altered flow guidance in which the accepted stock A from the accepted-stock chamber 3 is not carried off downwards, as in FIG. 1, but upwards, i.e., the accepted-stock outlet 9′ is centrally connected to the upper wall of the accepted-stock chamber 3. The accepted stock A thus drawn off then also contains air in addition to the screened fibers, which is why a further vent line can be dispensed with. The heavy particles centrifuged outwards in the inflow chamber 4 are guided directly downwards to the heavy-particle sluice 13 through a vertical or oblique heavy-particle channel 18 projecting radially on the housing 2. This embodiment (“heavy-particle trap”) prevents lengthy rotation of heavy particles in the housing and is also possible with the screening shown in FIGS. 1 and 4. Moreover, the device according to FIG. 3 features a possibility for better guiding rejected heavy particles into the heavy-particle sluice 13 with the aid of an incline 17 on a continuation of the inflow chamber 4 lying under the accepted-stock chamber 3. The inflow chamber 4 is closed at the top by an incline 20, to the highest point of which the light-particle outlet 11′ is connected.

The pressurized screen in FIG. 4 is provided with an inflow chamber 4′, the cross section of which is kept essentially constant over the axial height, since a tapering section has been dispensed with here. A special separate light-particle collection chamber above the wire 1 can also be omitted if necessary in order to save on construction height. The light particles are immediately guided away through the light-particle outlet 11. An end wall 19 running obliquely downwards is located in the lower part of the inflow chamber 4′, which wall guides the heavy particles arriving there together with the reject R out of the housing through the reject outlet 10. Expediently the reject outlet 10 is connected at the lowest point. A further heavy-particle outlet can then also be omitted. The end wall 19 can have an arched shape.

As already mentioned, the preferred use of this device is the prescreening or coarse screening of slushed paper stock. According to FIG. 5 this can typically be a recovered-paper suspension formed of recovered paper P and water W and drawn off through a coarse pulper wire 22. Such a pulper wire 22 is kept clear by a rotor 23 and usually has holes with a diameter between 10 and 25 mm. The recovered-paper suspension drawn off through this is pumped without any other wire device via stock pump 24 into the inflow 8 of a pressurized screen embodied according to the invention. This suspension S can therefore be mixed with a larger quantity of foreign bodies which can easily be held back at the screen openings, the diameter of which is, e.g., in a range between 1 and 3 mm.

In other uses such contaminated recovered-paper suspensions can be produced in a high-consistency pulper or in a dissolving drum with downstream open wire device, such as, e.g., an open screening drum, and dilution. A dissolving drum which is suitable for the method is shown, e.g., by German patent application DE 197 36 143.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A pressurized screen for screening a fibrous suspension, comprising:
a housing:
at least one wire arranged in said housing, said at least one wire having a plurality of openings and a center line of running essentially vertically;
a tangential inflow coupled to an inflow chamber;
an accepted-stock chamber coupled to an accepted-stock outlet, said at least one wire being positioned in a flow path between said inflow chamber and said accepted-stock chamber;
at least one reject outlet;
a driven wire scraper located in said accepted-stock chamber driven in a circumferential direction opposed to an inflow direction of the suspension through said tangential inflow; and
a light-particle outlet coupled to an upper part of said inflow chamber.

2. The pressurized screen in accordance with claim 1, wherein said at least one wire is cylindrical or conical.

3. The pressurized screen in accordance with claim 1, wherein said at least one wire is positioned to separate said accepted-stock chamber, which lies radially inside from said inflow chamber, which lies radially outside.

4. The pressurized screen in accordance with claim 1, further comprising a heavy-particle outlet, wherein said inflow chamber is connected to said heavy-particle outlet.

5. The pressurized screen in accordance with claim 4, wherein said heavy-particle outlet is coupled to a lower part of said inflow chamber.

6. The pressurized screen in accordance with claim 4, wherein an intermittently activatable heavy-particle sluice is coupled to said heavy-particle outlet.

7. The pressurized screen in accordance with claim 1, said inflow chamber has a conically tapering section.

8. The pressurized screen in accordance with claim 1, wherein said inflow lies geodetically above said reject outlet.

9. The pressurized screen in accordance with claim 1, further comprising a vent line coupled at an upper part of said accepted-stock chamber.

10. The pressurized screen in accordance with claim 1, wherein said wire scraper is embodied to generate pressure and suction impulses to a surrounding liquid in the direction of said wire through relative movement with said wire.

11. The pressurized screen in accordance with claim 1, wherein said inflow chamber is closed below by an incline, and said heavy-particle outlet is coupled to a lowest point of said incline.

12. The pressurized screen in accordance with claim 1, wherein said inflow chamber is closed below by an end wall running obliquely, and said reject outlet is coupled to a lowest point of said end wall.

13. The pressurized screen in accordance with claim 1, wherein said inflow chamber is closed above by an incline, and said light-particle outlet is coupled to a highest point of said incline.

14. A process for cleaning a suspension produced from recovered paper in the pressurized screen in accordance with claim 1, comprising:
producing a suspension by slushing in a dissolving drum; and
holding back foreign particles contained in the suspension at wire openings due to size, type and shape.

15. The process in accordance with claim 14, wherein the wire openings are round with a diameter greater than 1 mm.

16. The process in accordance with claim 15, wherein the diameter is greater than preferably greater than 3 mm.

17. The process in accordance with claim 14, further comprising:
screening and diluting the suspension in the wire; and
pumping the suspension into the pressurized screen.

18. A process for cleaning a suspension produced from recovered paper in the pressurized screen in accordance with claim 1, comprising:
producing a suspension by slushing in a pulper; and
holding back foreign particles contained in the suspension at round wire openings having a diameter greater than 1 mm due to size, type and shape.

19. The process in accordance with claim 18, wherein the diameter is greater than 3 mm.

20. The process in accordance with claim 18, further comprising pumping the suspension from the pulper directly into the pressurized screen through the at least one wire arranged in the pulper.

21. The process in accordance with claim 18, wherein the suspension is guided into the pressurized screen with a consistency between 2% and 4%.
